(19) United States
(12) Patent Application Publication
(10) Pub. No.: US 2021/0194708 A1
(43) Pub. Date: Jun. 24, 2021

(54) POWER DROOP COMPENSATION FOR DC POWER SOURCING EQUIPMENT

(71) Applicant: SIGNIFY HOLDING B.V., EINDHOVEN (NL)

(72) Inventor: MATTHIAS WENDT, WÜRSELEN (DE)

(21) Appl. No.: 16/075,831

(22) PCT Filed: Jan. 25, 2017
(86) PCT No.: PCT/EP2017/051474

§ 371 Date: Aug. 6, 2018

(30) Foreign Application Priority Data
Feb. 5, 2016 (EP) 16154378.0

(51) Int. Cl. H04L 12/10; H02J 1/10

(52) U.S. Cl. CPC H04L 12/10; H02J 1/109

(57) ABSTRACT

A power droop handling device (400) for controlling DC electrical power delivery from an external power sourcing equipment (PSE, 402) to an external electrical load device (404) in response to the PSE receiving a predetermined maintain-power-signature pulse from the load device, wherein the power droop handling device comprises a droop sensor unit (406) configured to receive power-delivery information regarding DC electrical power delivery from the PSE to the load device and to provide a droop warning signal indicative of a power-droop condition, and a control unit (408) configured to output, in response to the droop warning signal, a maintain-operation signal to the PSE instructing the PSE to maintain the power delivery to the electrical load device for a predetermined time span, regardless of whether or not the maintain-power-signature pulse is detected during this time span.

### FIELD OF THE INVENTION

The present invention is in the field of DC power supply systems, such as for instance, but not limited to, Power over Ethernet (PoE) technology.

In particular, the present invention relates to a power droop handling device for controlling DC electrical power delivery from an external power sourcing equipment to an external electrical load device, the power being delivered in response to the power sourcing equipment receiving from the electrical load device a predetermined maintain-power-signature pulse that is repeated according to a repetition rule. It further relates to a power sourcing equipment for delivering DC electrical power to at least one external electrical load device in response to detecting a predetermined maintain-power-signature pulse from the electrical load device. The invention further relates to an electrical arrangement comprising power sourcing equipment, a power droop handling device, and an electrical load device. It further relates to a droop handling method for controlling DC electrical power delivery from an external power sourcing equipment to an external electrical load device and to a method for operating a power sourcing equipment in delivering DC electrical power to at least one external electrical load device in response to detecting a predetermined maintain-power-signature pulse from the electrical load device.

### BACKGROUND OF THE INVENTION

It is known in DC power supply systems supplying electrical load devices with DC power via respective connection ports to detect if any of the powered electrical load devices is unplugged rather than operated in a standby mode. When the electrical load device becomes unplugged, the power supply device must avoid providing a voltage at the now open connection port. Thus, the power supply device must quickly switch off the DC supply voltage at the connection port that is now open.

To allow a distinction of such events from the standby mode, it is known to require the electrical load device to draw a certain amount of minimum power over a predetermined time span.

In PoE systems, for instance, a maintain power signature (MPS) requirement is employed. MPS is a minimum power signature that a powered electrical load device must draw to ensure that it remains powered. The MPS can be defined by way of a certain minimum current, which must be present for only a certain time span, e.g. on the order of milliseconds, within a predetermined period, e.g. on the order of hundreds of millisecond at a connection port, to which the electrical load device is connected. The MPS can thus be identified as an AC power feature, in particular a short pulse of current (and thus power) that is provided periodically as long as the electrical load device is to be powered. Since the powered electrical load device triggers the provision of the pulsed MPS feature in the power delivery, it can be said that the PSE receives an MPS pulse from the electrical load device.

The power supply device, or, in terms used in PoE systems, the power sourcing equipment (PSE), thus delivers power to a powered electrical load device in response to the PSE receiving from the electrical load device a predetermined MPS pulse that is repeated according to a predetermined repetition rule. Different PoE standard versions and different PSE device types provide different requirements on the MPS pulses and on the repetition rule.

US 2009/0085586 A1 describes an AC maintain power signature detection circuit in a PSE for a PoE system. To facilitate the detection of the AC maintain power signature at a connection port supplying power to a powered electrical load device, the AC maintain power signature detection circuit injects an AC test signal onto a connection port of the PSE. The AC test signal is driven onto a first power terminal of the connection port through a sense resistor. The voltages across the sense resistor are measured and scaled by first and second resistor dividers having different resistor ratios. The voltage and the scaled voltage at the first power terminal side of the sense resistor have a peak voltage that is proportional to the load impedance of the load coupled to the connection port. The comparator compares the scaled voltages measured across the sense resistor and generates the output signal indicative of the load impedance at the connection port.

### SUMMARY OF THE INVENTION

It has been recognized by the inventor that unintentional interruptions in power delivery from the PSE to powered electrical load devices may occur under power-droop conditions. A power-droop condition typically implies a sudden drop in PSE voltage. It is therefore an object of the present invention to avoid an undesirable discontinuation of power delivery from a power sourcing equipment to a connected electrical load device under a power-droop condition.

According to a first aspect of the present invention, a power droop handling device for controlling DC electrical power delivery from an external power sourcing equipment to an external electrical load device, the power being delivered in response to the power sourcing equipment receiving from the electrical load device a predetermined maintain-power-signature pulse that is repeated according to a repetition rule, is presented. The power droop handling device comprises:
a droop sensor unit configured to receive power-delivery information regarding DC electrical power delivery from the external power sourcing equipment to the external electrical load device, and to provide, based on the received power-delivery information, a droop warning signal indicative of a power-droop condition defined by a power amount to be delivered from the power sourcing equipment to the load device falling below a predetermined power threshold value;
a control unit configured to receive the droop warning signal, and, in response to receiving the droop warning signal, to output a maintain-operation signal to the external power sourcing equipment, the maintain-operation signal instructing the power sourcing equipment to maintain the power delivery to the electrical load device for a predetermined time span, regardless of whether or not the maintain-power-signature pulse is detected during this time span.

The power droop handling device of the first aspect of the invention is based on the following recognitions and considerations:

MPS pulses may be provided with rather low current amplitudes and rather low frequencies. Therefore, there is a risk of the PSE missing MPS pulses that have been generated. Missing an MPS pulse, however, immediately results in an undesirable discontinuation of power delivery to a corresponding electrical load device as the PSE erroneously considers that electrical load device disconnected from the connection port. The present invention recognizes that one of the conditions that may cause the PSE to miss one or more MPS pulses is a power-droop condition. A sudden drop in the PSE voltage that occurs under a power-droop condition can be caused for example when a sudden load change occurs in the PSE. In PoE lighting systems, for instance, multiple luminaires are connected to a number of ports of a single PSE. One simple exemplary cause of a power-droop condition can be switching on multiple luminaires in one moment of time. Other causes for a power-droop condition are control instabilities in the power supply of the PSE.

The droop handling device of the first aspect of the present invention is advantageously configured to maintain the delivery of DC power from a PSE to an electrical load device even under a power-droop condition. The droop sensor unit receives power delivery information regarding DC electrical power delivery from the external power sourcing equipment to the external electrical load device and is thus configured to identify the occurrence of a power-droop condition which happens when a power amount to be delivered from the PSE to the electrical load device falls below a predetermined power threshold value. In this case, a droop warning signal is provided by the droop sensor unit. In response to the droop warning signal, a control unit provides a maintain-operation signal for reception by the external PSE. This maintain-operation signal contains an instruction to the external PSE to maintain the power delivery to the electrical load device for a predetermined time span, regardless of whether or not the maintain-power-signature pulse is detected during this time span.

Thus, once the external PSE receives the maintain-operation signal, it is put in a position that allows overriding any detection of a missing MPS pulse which would otherwise be interpreted by the PSE as an instruction to discontinue power delivery to the electrical load device.

In the following, embodiments of the power handling device of the first aspect of the present invention will be described.

The power droop handling device of the first aspect of the invention is in some embodiments implemented as an optional extension to a PSE and thus configured to be connected with a PSE or disconnected from the PSE by installation staff. For example, the power droop handling device can be implemented as a power droop handling module configured to be connected internally to connection port circuitry within the PSE via a suitable internal electrical interface. In such embodiment, one respective power droop handling module is suitably provided for a given one of the connection ports of the PSE. Still, since the power droop handling module is configured to be removable from the PSE in such embodiments, the PSE is to be considered external with respect to the power droop handling module.

In another example, the power droop handling device is configured to be connected to the PSE via one of its connection ports that are also used for connecting electrical load devices. Such embodiments require the PSE to provide to the power droop handling device the power-delivery information pertaining to another connection port, to which the power droop handling device is allocated. Allocation of the power droop handling device to that other connection port can be achieved by making suitable settings at the PSE during setup of a given electrical arrangement that comprises the PSE.

The power delivery information regarding the DC electrical power delivery may be a direct measure of an electrical characteristic indicative of the power delivered, such as voltage or current. In one embodiment, the power droop handling device comprises a power sensor unit which is configured to be connected with the power sourcing equipment, to determine a power amount currently delivered from the power sourcing equipment to the load device and to provide to the droop sensor unit the power-delivery information as a power signal indicative of the power amount currently delivered from the power sourcing equipment to the load device. In this embodiment, the power sensor unit determines the amount of power which is currently delivered from the PSE to the electrical load device by measuring an electrical characteristic indicative of the DC power delivered, such as voltage or current, and provides the power-delivery information to the droop sensor unit. The power-delivery information is provided in the form of a power signal. In a variant of this embodiment, the power-delivery information is derived from the DC voltage and DC current provided by the PSE to the electrical load. In another variant, only the DC voltage is measured and the power-delivery information is estimated based on this value.

However, also indirect measures of power delivery can be used in some embodiments as an alternative or in addition to a direct measure of power delivery. For instance, information on operation of connected electrical load devices or information on operational changes such as an on/off switching or dimming of an electrical load device can be used to derive information on a risk of a power-droop condition without actually measuring power delivery. Whenever the droop sensor unit senses an imminent risk of occurrence of a power droop by detecting operational situations that, upon occurring, are classified as likely leading to a power-droop condition, the droop warning signal is generated in such embodiments.

In one such embodiment the droop sensor unit further comprises a data analysis unit which is configured to receive the power-delivery information in the form of power control data that is exchanged or to be exchanged between the external power sourcing equipment and the external electrical load device, the power control data being indicative of an operational status or instruction regarding power delivery from the power-sourcing equipment to the electrical load device and determine or forecast an occurrence of the power-droop condition based on the received power control data. The power control data exchange between PSE and electrical load device may include but is not limited to, instructions to switch on or off a particular electrical load device or to adjust the power delivered to it. In systems where a plurality of electrical load devices are connected to a PSE, if a set of electrical load devices requires power adaptation in a short time span (e.g. a group of luminaries connected to a PSE requires to be switched on almost simultaneously), this embodiment is configured to determine or forecast, based on the power control data, an occurrence of the power-droop condition. This embodiment is thus able to advantageously output the maintain-operation signal to the PSE even before an expected droop situation actually takes place.

Information regarding sets or combinations of power control data that may lead to a power-droop condition is in some embodiments prestored. In other embodiments, the effect of missing maintain-power-signature pulses during power-droop conditions resulting from a respective power control data gets registered by the data analysis unit by employing a learning algorithm. In some embodiments such learning algorithm is performed during operation of the PSE/droop handling device/electrical load device system without any loss of comfort by deactivating the maintain-power-signature pulse detection at the PSE. It should be clear that if the maintain-power-signature detection is not active, power is still delivered even when the electrical load devices are disconnected. Once a learning phase is over, the detection mechanism should be reactivated.

In another embodiment, the maintain-operation signal is provided as an instruction to the power sourcing equipment to request the load device to provide the maintain-power-signature pulse with a an increased pulse power. In situations where the maintain-power-signature pulses get missed more often than expected, this embodiment is advantageously allows a temporary provision of a maintain-power-signature pulses with a higher power, which is in turn easier to detect at the PSE. In particular, some embodiments may include in the maintain-operation signal an instruction to the PSE to provide a request to the load device for providing the maintain-power-signature pulse using a predetermined higher power mode comprised by a plurality of power modes. The plurality of power modes also includes as default mode a lower power mode drawing less power with an MPS pulse than the higher power mode.

According to a second aspect of the present invention a power sourcing equipment for delivering DC electrical power to at least one external electrical load device in response to detecting a predetermined maintain-power-signature pulse from the electrical load device is presented. The power sourcing equipment comprises a power unit which is configured to provide the DC electrical power, an interface unit comprising at least one connection port, which is connected with the power unit and configured to output the electrical power to the external electrical load device, and to receive the maintain-power-signature pulse from the electrical load device. It further comprises at least one power droop handling device of the first aspect of the present invention or one of its embodiments, which is connected with the power unit for sensing the power amount delivered from the power sourcing equipment to the load device, and a power sourcing control unit, which is connected with the connection port and which is configured to discontinue the power delivery to the electrical load device upon establishing a missing-pulse condition in which a respective maintain-power-signature pulse expected according to the repetition rule has not been received, and upon additionally receiving the maintain-operation signal from the power droop handling device under the missing-pulse condition, to temporarily maintain the power delivery to the electrical load device for a predetermined time span.

The power sourcing equipment of the second aspect of the present invention shares the advantages of the power droop handling device of the first aspect of the invention. It is advantageously configured to maintain the power delivery to an electrical load device connected to it through a connection port even in situations where the load device is still connected but the maintain-power-signature pulse has not been detected or are not expected to be detected due to the current or future system status.

The power sourcing control unit is generally configured to discontinue the power delivery to the electrical load device upon establishing a missing-pulse condition. The missing-pulse condition is therefore generally interpreted as a sign of the electrical load device being disconnected from the power sourcing equipment. Power delivery is thus discontinued to avoid the delivery of power to an open connection port. Nevertheless, the power sourcing equipment of the second aspects opens a route to dismiss the missing-pulse condition and maintain the power delivery under a predefined power-droop condition. If the power droop handling device outputs a maintain-operation signal based on power delivery information regarding DC electrical power delivery from the PSE to the electrical load device, as described hereinabove, the power delivery will be maintained for a predetermined time span regardless of a missing-pulse condition. Therefore, if a power-droop condition is signaled by the power droop handling device, the power sourcing control unit will not discontinue the power delivery during a predetermined time span and an undesirable discontinuation of the power supply will be avoided.

While the present specification recognizes that the term power sourcing equipment has a specific meaning in the field of PoE technology, such a power sourcing equipment suitable for operation according to a PoE standard is to be considered as an embodiment among other embodiments. Compliance with a PoE standard is thus not a necessary requirement for the power sourcing equipment according to the second aspect of the invention. Any DC power supply technology that makes use of a MPS feature as described above can advantageously make use of the power sourcing equipment of the second aspect of the present invention. Thus, the power sourcing equipment is in some embodiments not compliant to a PoE standard, but such other DC power supply technology.

Different embodiments of the power sourcing equipment of the second aspect comprise the additional features of one embodiment or a combination of the additional features of a plurality of embodiments of the power droop handling device of the first aspect. Such embodiments of the power sourcing equipment share the respective advantages of the respective power droop handling device embodiments.

In the following, additional embodiments of the power sourcing equipment will be described.

The power unit is in some embodiments connected to an external power supply (e.g. mains power supply) and is configured to adapt or transform the external power supply to the DC power requirements of the electrical load device. The interface unit comprises a plurality of connection ports to which the external load devices are connected.

The connection between the power sourcing equipment and the electrical load device is achieved in some embodiments through a patch cable configured to transmit power supply. In other embodiments the patch cable is further configured to further transmit power control data. In a particularly advantageous embodiment, the power sourcing equipment is configured to transmit DC power to the electrical load device via the connection port in accordance with requirements of a PoE standard.

In one embodiment, the power sourcing control unit is configured, upon receiving the maintain-operation signal from the power droop handling device, to pause a detection of the maintain-power-signature pulse for the predetermined time span. This particular embodiment has the advantage of an easy implementation, since the power sourcing control unit is configured to simply pause the detection of the maintain-power-signature pulse for the predetermined time span once the power droop handling device has output the maintain operation.

In another embodiment, the power sourcing control unit is configured, upon receiving the maintain-operation signal from the power droop handling device, to disregard any detected maintain-power-signature pulse for the predetermined time span. In this case, the sourcing control unit is still configured to detect the maintain-power-signature pulse upon receiving the maintain-operation signal output by the power droop handling device. This enables the power sourcing equipment to monitor, in dependence on the electrical load device and the power droop, the missing-pulse conditions caused by said power droop.

In another embodiment, the power sourcing control unit is configured to return to normal power delivery upon establishing that the missing-pulse condition has ended. In this case, if the missing-pulse condition ends before the predetermined time span has lapsed, the time span lapses at the moment the missing-pulse condition ends, and the system returns to normal power delivery, dependent again on the detection of the maintain power signature pulses and the detection of power-droop conditions. Normal power delivery is to be understood as the power delivery from the PSE to the electrical load device while the maintain-power-signature pulse is being detected and the power droop handling device has not detected a power-droop condition.

In another embodiment, the power sourcing control unit is configured, in case a missing-pulse condition ends before the time span has lapsed, to initialize a second time span upon establishing a reoccurrence of the missing-pulse condition during the predetermined (first) time span. In this particular embodiment, if during the predetermined (first) time span, a detected missing-pulse condition ends and a second missing-pulse condition is detected also during the (first) time span, the power sourcing unit is configured to stop the (first) time span and start a second time span upon detecting the second missing-pulse condition. The (first) time span is suitably set to last longer than an expected typical duration of the missing-pulse condition. This embodiment is particularly advantageous in situations where the predetermined (first) time span would lapse during a second missing-pulse condition that is detected after the original missing-pulse condition has ended. It avoids that after the lapse of the (first) time span the power sourcing unit would interpret the findings as an ongoing missing-pulse condition and would therefore undesirably discontinue the power delivery to the electrical load device.

In another embodiment, the power sourcing control unit further comprises a timing unit which is configured to determine and store a duration of an established missing-pulse condition, and to determine an extension of the time span in dependence on the stored duration. This embodiment enables the adaptation of the predetermined time span to the particularities of the PSE/electrical load device system. The time extension of the missing-pulse condition depends mainly on the electrical characteristics of the load device (e.g. equivalent impedance) and on a magnitude of the power drop. The power sourcing control unit of this embodiment keeps track of the missing maintain-power-signature pulses to determine the duration of the established missing-pulse condition for a respective detected power droop and a respective electrical load device. It is then further configured to determine the extension of the time span based on the determined duration of the missing-pulse condition.

In another embodiment, the timing unit is further configured to initialize monitoring the time span upon receiving the maintain-operation-signal, to stop monitoring the time span upon establishing that the missing-pulse condition has ended before the time span has lapsed and to discontinue the power delivery to the electrical load device when the time span has lapsed without discontinuation of the missing-pulse condition. In this embodiment, the predetermined time span is only monitored as long as the maintain-power-signature pulses are not detected, i.e. during the missing-pulse condition. Should the missing-pulse condition end before the time span lapses, the timing unit stops monitoring the time span and the power sourcing equipment of this embodiment returns to normal power delivery. The power delivery to the electrical load device is discontinued only if the missing-pulse condition remains after the predetermined time span has lapsed.

As indicated above, in some embodiments the power sourcing equipment of the second aspect of the present invention comprises the power droop handling device as an internal unit within a housing of the power sourcing equipment. In some of these embodiments a single droop handling device centrally controls the DC power delivery to all electrical loads connected to the PSE, whereas in other embodiments, each connection port is connected to a respective power droop handling device, which controls the DC power delivery to the electrical load connected to that port independently of the other electrical loads. Having the at least one droop handling device together with the PSE within a common housing simplifies the installation for installation staff.

According to a third aspect of the present invention, an electrical arrangement is provided. The electrical arrangement comprises a power sourcing equipment according to the second aspect of the present invention or one of its embodiments, wherein the interface unit has at least two ports, a power droop handling device according to the first aspect of the present invention or one of its embodiments, that is connected to the power sourcing equipment through a first connection of the at least two connection ports, and an electrical load device that is connected to the power sourcing equipment through a second connection port of the at least two connection ports.

Different embodiments of the electrical arrangement of the third aspect comprise different embodiments of the power droop handling devices of the first aspect and of the power sourcing equipment of the second aspect, and the resulting embodiment of the electrical arrangement shares the advantages of the respective power droop handling device and power sourcing equipment.

According to a forth aspect of the present invention, a droop handling method for controlling DC electrical power delivery from an external power sourcing equipment to an external electrical load device is provided, the power being delivered in response to the power sourcing equipment receiving from the electrical load device a predetermined maintain-power-signature pulse that is repeated according to a repetition rule is presented. The droop handling method comprises:
receiving power-delivery information regarding DC electrical power delivery from the external power sourcing equipment to the external electrical load device,
providing, based on the received power-delivery information, a droop warning signal indicative of a power-droop condition defined by a power amount to be delivered from the power sourcing equipment to the load device falling below a predetermined power threshold value;
in response to the droop warning signal, providing a maintain-operation signal to the external power sourcing equipment, the maintain-operation signal instructing the power sourcing equipment to maintain the power delivery to the electrical load device for a predetermined time span, regardless of whether or not the maintain-power-signature pulse is detected during this time span.

According to a fifth aspect of the present invention, a method for operating a power sourcing equipment in delivering DC electrical power to at least one external electrical load device in response to detecting a predetermined maintain-power-signature pulse from the electrical load device is presented. The method comprises:
providing the DC electrical power to the electrical load device;
receiving the maintain-power-signature pulse from the electrical load device;
performing a droop handling method according to the forth aspect of the present invention;
upon receiving the maintain-operation signal during performance of the droop handling method of the forth aspect of the present invention under a missing-pulse condition, in which a respective maintain-power-signature pulse expected according to the repetition rule has not been received, temporarily maintaining the power delivery to the electrical load device for a predetermined time span; and
discontinuing the power delivery to the electrical load device upon establishing that the missing-pulse condition continues after the predetermined time span has lapsed.

It shall be understood that the power droop handling device of claim 1, the power sourcing equipment of claim 5, the electrical arrangement of claim 13, the droop handling method of claim 14 and the method for operating a power sourcing equipment of claim 15 have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 and FIG. 2 show simplified circuit diagrams of an electrical load device,

FIG. 3 shows a simulation showing the effect of a power droop,

FIG. 4 shows a block diagram of an embodiment of a power droop handling device connected to an external power sourcing equipment and to an external electrical load device,

FIG. 5 shows a block diagram of an embodiment of a power sourcing equipment connected to electrical load devices,

FIG. 6 shows a block diagram of another embodiment of a power sourcing equipment connected to electrical load devices,

FIG. 7 shows a flow diagram of an embodiment of a droop handling method, and

FIG. 8 shows a flow diagram of an embodiment of a method for controlling DC electrical power delivery

### DETAILED DESCRIPTION OF EMBODIMENTS

In powering systems, such as but not limited to, Power over Ethernet, where it is mandatory to remove electrical power if an electrical load device is unplugged from the power supply device/power sourcing equipment to avoid voltages being present at an open connector, a strategy commonly used is to configure the power sourcing equipment (PSE) to detect a maintain-power-signature pulse which is repeated according to a repetition rule. The detection of the expected MPS pulses is interpreted by the PSE as a sign that the electrical load device is connected to the system.

Following the example of Power over Ethernet, IEEE Standard 802.3-2005 section 33.2.10 sets the requirements for maintain-power-signature pulses. According to the IEEE Standard, as of 2015, power sourcing equipment must monitor a power port that is powered up for the presence of a MPS. The MPS has different power modes. For some electrical load devices, the MPS is defined to be 10 mA. This current is called IHold. This figure puts the lower bound power consumption (i.e. the power mode) at least on 50V*10 mA=500 mW. It was recognized that this lower bound limit was too high to achieve low standby, hence the standard also has the provision to duty cycle this current. The rule is that the IHold current only must be present for 75 ms out of every 325 ms period. This reduces the lower bound power consumption (i.e. the power mode) to approximately 115 mW. The 802.3bt amendment introduces two new types of electrical loads, namely Type 3 & Type 4, which are required to show the MPS for 7 ms out of every 300 ms period. When the MPS is absent, the PSE must discontinue supplying power to the power port.

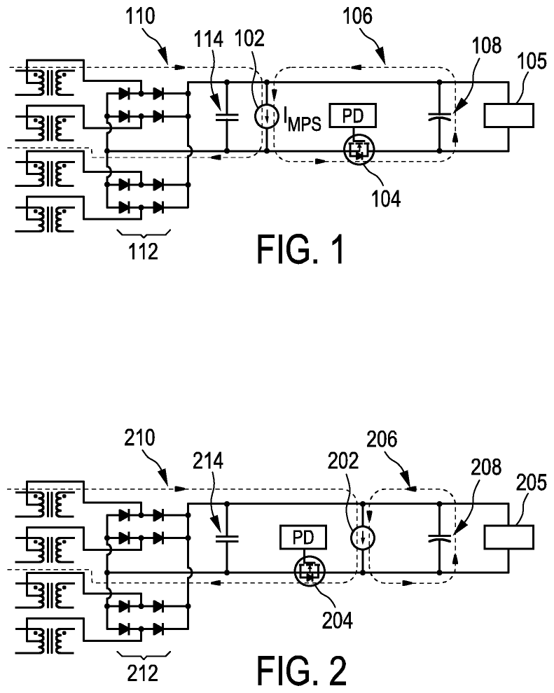

In FIG. 1 and FIG. 2 simplified electrical load device circuit diagrams are shown. In FIG. 1 a maintain-power-signature (MPS) pulse generator 102 is positioned between a powered device (PD) interface comprising a hot swap FET 104 and a power sourcing equipment (PSE, not shown). In FIG. 2 an MPS pulse generator 202 is positioned between a PD interface comprising a hot swap FET 204 and a load 205.

The diagrams illustrate the underlying problem, namely the existence of undesirable current paths 106, 206 where the MPS is provided by the bulk capacitors 108 and 208, whereas in the desirable current paths 110, 210 the MPS is drawn from the PSE.

When the MPS, or another current based on a minimum current requirement, is at least partially not drawn from the power supply (e.g. PSE) then, when measured at the power supply side of the power distribution system (i.e. at the PSE), the minimum current requirement might not be met. Such a requirement is set to allow, for example a PSE, to detect if an electrical load device becomes unplugged from the cable. In such an event, the PSE must quickly remove the voltage to avoid voltages to be present on an open connector. In other words, the MPS is the minimum power signature an electrical load must draw from the power source to ensure that it remains powered. Short pulses such as the ones allowed for type 3 and 4 systems (required to show the MPS for 7 ms out of every 300 ms) are hard to detect on the PSE side and can even be masked in droop situations. Due to droop effects in the PSE power supply, the supplied voltage gets reduced and this mostly causes the rectifier diodes 112, 212 in the PD to isolate. In the undesirable current paths 106 and 206, the MPS pulse is provided the respective bulk capacitor 108 and 208. In the desirable current paths 110 and 210 the MPS current is drawn from the PSE. As reflected in the simplified circuits shown in FIG. 1 and FIG. 2, if the voltages at the input capacitors 114, 214 are higher than the PSE voltages (the reason for this being, for example, a power droop), the rectifier diodes 122, 124 will stop conducting and no MPS can flow into the PSE.

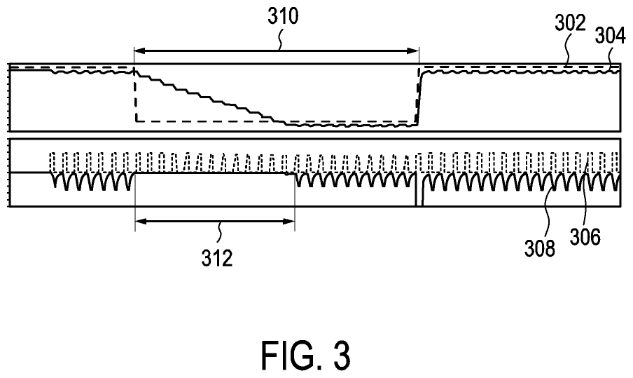

Such a power droop is shown in the simulation of FIG. 3. The PSE voltage 302 is shown, it transitions from 57V to 50V and back to 57V. Also shown is the voltage 304 over the bulk capacitor (e.g. 108, 208). The MPS current on the PD side is shown 306 as well as the current as observed by the PSE 308. While the pulses in 308 are filtered and reduced in amplitude during the period of high PSE voltage, they completely disappear after the voltage has dropped to 50V and only reappear later once the bulk capacitor has discharged sufficiently. The absence of detected MPS pulses caused by the voltage droop and not intentionally, may lead cause the PD to be accidentally turned off. Time span 310 approximately indicates the duration of the power droop, whereas time span 312 approximately indicates the time during which the MPS pulse 308 is not detected at the PSE. This time span 312 depends on the amount of voltage loss during the droop and on the capacitance value of the bulk capacitor.

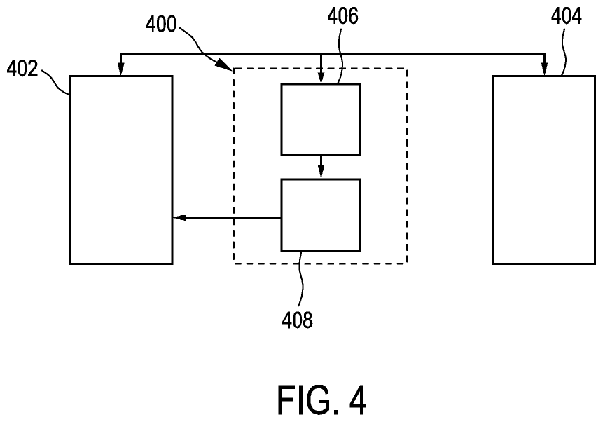

FIG. 4, also in reference to FIG. 3, shows a power droop handling device 400 for controlling DC electrical power delivery from an external power sourcing equipment 402 to an external electrical load device 404. The power 302 is delivered in response to the power sourcing equipment receiving from the electrical load device a predetermined maintain-power-signature pulse 308 that is repeated according to a repetition rule. The power droop handling device comprises a droop sensor unit 406 configured to receive power-delivery information regarding DC electrical power delivery from the external power sourcing equipment to the external electrical load device, and to provide, based on the received power-delivery information, a droop warning signal indicative of a power-droop condition. A power-droop condition takes place when a certain power amount delivered or to be delivered from the power sourcing equipment to the load device falls or is going to fall below a predetermined power threshold value. Additionally it comprises a control unit 408 configured to receive the droop warning signal, and, in response to receiving the droop warning signal, to output a maintain-operation signal to the external power sourcing equipment. The maintain-operation signal instructs the power sourcing equipment to maintain the power delivery to the electrical load device for a predetermined time span, regardless of whether or not the maintain-power-signature pulse is detected during this time span. The time span is preferably longer than the time span 312 to avoid undesired discontinuation of the power supply.

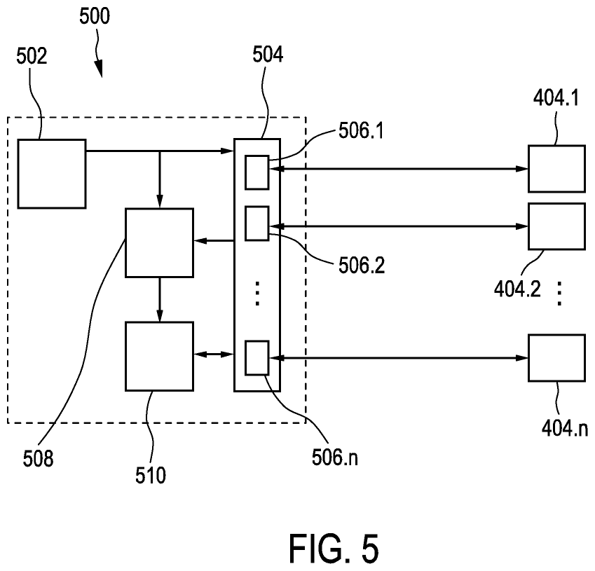

FIG. 5 represents a block diagram of a power sourcing equipment 500 for delivering DC electrical power to a plurality of external electrical load devices 404.1, 404.2, 404.n in response to detecting a predetermined maintain-power-signature pulse (e.g. signal 308) from each respective electrical load device. The PSE comprises a power unit 502, configured to provide the DC electrical power to the load device. It also comprises an interface unit 504 comprising a plurality of connection ports 506.1, 506.2, 506.n. The interface unit is connected with the power unit and configured to output the electrical power to the external electrical load device, and to receive the maintain-power-signature pulse from the electrical load device. The connection between the PSE and an electrical load device is performed through a patch cable configured to transmit electrical power and operational instructions (i.e. power supply and connectivity data). The PSE further comprises a power droop handling device 508 according to this invention, which is connected with the power unit for sensing the power amount delivered from the power sourcing equipment to the load device and to the interface unit to receive power control data. The PSE also comprises a power sourcing control unit 510, which is connected with the interface unit and which is configured to discontinue the power delivery to the electrical load device upon establishing a missing-pulse condition in which a respective maintain-power-signature pulse expected according to the repetition rule has not been received, and upon additionally receiving the maintain-operation signal from the power droop handling device under the missing-pulse condition, to temporarily maintain the power delivery to the electrical load device for a predetermined time span.

In this example, the power sourcing control unit 510 detects the maintain-power-signature pulses from the plurality of load devices. The load devices are powered by the power unit 502, which is configured to provide the DC electrical power. The power droop handling device 508 is here configured to receive power-delivery information both in terms indicative of the power amount delivered from the PSE to the electrical load device and of an operational status or instruction regarding the power delivery, i.e. in form of power control data which is exchanged between the PSE and the load devices. The power droop handling device is therefore configured to detect a droop condition based on the amount of power being currently delivered to the electrical load devices and to forecast an imminent droop situation based on the actual power control data exchanged. For example, if due to an instability in the power unit, the power provided falls below a predetermined power threshold value, the droop handling device will output the maintain-operation signal to the power sourcing sensor unit, which would otherwise, upon establishing a missing-pulse condition, undesirably discontinue the power delivery to the electrical load device. The power droop handling device 508 is further configured to receive power control data exchanged between the PSE and the load devices. If the power droop handling device receives power control data from a plurality of load devices requesting to be switched on or otherwise to drastically change their operational status in a very short time span, it is configured to output the maintain-operation signal to the power sourcing unit, ensuring the delivery of power during a predetermined time span independently of the occurrence of a power droop situation.

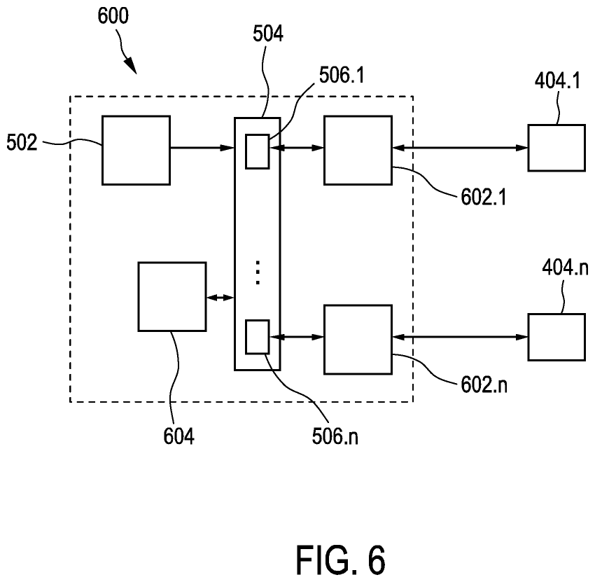

FIG. 6 is a block diagram of another embodiment of a power sourcing equipment 600 comprising a power unit 502, an interface unit 504 with a plurality of connection ports 506.1 to 506.n. The PSE further comprises a power sourcing control unit 504. In this embodiment, a plurality of power droop handling devices 602.1, 602.n are connected to the connection ports 506.1 506.n and to the electrical load devices 404.1 and 404.n. The power droop handling devices receive through the connection port power delivery information in form of the power amount currently delivered to the load device which is connected to it. It also receives power delivery information in form of power control data that is exchanges or to be exchanged between the PSE and the electrical load device. The power droop handling devices are also connected with the power sourcing control unit 604 through the interface unit. The power sourcing control unit is able to discontinue or to maintain the power delivery according to the detection of the maintain-power-signature pulse from the electrical load devices (404.1, 404.n) and the maintain-operation signal from the respective power droop handling device (602.1, 602.n). The devices 404.1 to 404.n can be detached networked electrical consumers like routers, switches, printer spoolers, webcams, luminaries, fans, sensors, user interface devices such displays or switch panels, etc.

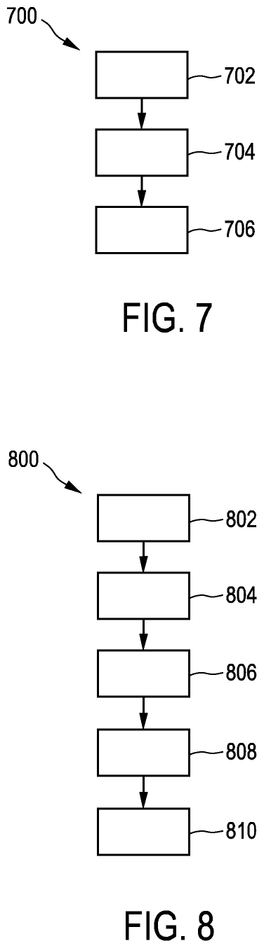

FIG. 7 represents a flow diagram describing a droop handling method 700 for controlling DC electrical power delivery from an external power sourcing equipment to an external electrical load device, the power being delivered in response to the power sourcing equipment receiving from the electrical load device a predetermined maintain-power-signature pulse that is repeated according to a repetition rule. The droop handling method 700 comprises receiving, in a first step 702, power-delivery information regarding DC electrical power delivery from the external power sourcing equipment to the external electrical load device. It then provides, in a step 704 and based on the received power-delivery information, a droop warning signal indicative of a power-droop condition defined by a power amount to be delivered from the power sourcing equipment to the load device falling below a predetermined power threshold value. Finally, and in response to the droop warning signal, it provides in a step 706 a maintain-operation signal to the external power sourcing equipment, the maintain-operation signal instructing the power sourcing equipment to maintain the power delivery to the electrical load device for a predetermined time span, regardless of whether or not the maintain-power-signature pulse is detected during this time span.

FIG. 8 represents a flow diagram describing a method 800 for operating a power sourcing equipment in delivering DC electrical power to at least one external electrical load device in response to detecting a predetermined maintain-power-signature pulse from the electrical load device. The method 800 comprises providing in a first step 802 the DC electrical power to the electrical load device, receiving, in a step 804 the maintain-power-signature pulse from the electrical load device, performing, in a step 806, a droop handling method 700 and upon receiving, in a step 808, the maintain-operation signal during performance of the droop handling method 700 under a missing-pulse condition, in which a respective maintain-power-signature pulse expected according to the repetition rule has not been received, temporarily maintaining the power delivery to the electrical load device for a predetermined time span, the method 800 finally discontinues, in a step 810, the power delivery to the electrical load device upon establishing that the missing-pulse condition continues after the predetermined time span has lapsed.

In summary thus, a power droop handling device for controlling DC electrical power delivery from an external power sourcing equipment (PSE) to an external electrical load device in response to the PSE receiving a predetermined maintain-power-signature pulse from the load device comprises a droop sensor unit configured to receive power-delivery information regarding DC electrical power delivery from the PSE to the load device and to provide a droop warning signal indicative of a power-droop condition, and a control unit configured to output, in response to the droop warning signal, a maintain-operation signal to the PSE instructing the PSE to maintain the power delivery to the electrical load device for a predetermined time span, regardless of whether or not the maintain-power-signature pulse is detected during this time span. Corresponding features are provided in a power sourcing equipment, an electrical arrangement, a power droop handling method and in a method for operating a power sourcing equipment.

While the present invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single step or other units may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1. A power droop handling device for controlling DC electrical power delivery from an external power sourcing equipment to an external electrical load device, the power being delivered in response to the power sourcing equipment receiving from the electrical load device a predetermined maintain-power-signature pulse that is repeated according to a repetition rule, the power droop handling device comprising:
a droop sensor unit configured to receive power-delivery information regarding DC electrical power delivery from the external power sourcing equipment to the external electrical load device, and to provide, based on the received power-delivery information, a droop warning signal indicative of a power-droop condition defined by a power amount to be delivered from the power sourcing equipment to the load device falling below a predetermined power threshold value; and
a control unit configured to receive the droop warning signal, and, in response to receiving the droop warning signal, to output a maintain-operation signal to the external power sourcing equipment, the maintain-operation signal instructing the power sourcing equipment to maintain the power delivery to the electrical load device for a predetermined time span, regardless of whether or not the maintain-power-signature pulse is detected during this time span.

2. The power droop handling device of claim 1, comprising
a power sensor unit configured to be connected with the power sourcing equipment, to determine a power amount currently delivered from the power sourcing equipment to the load device and to provide to the droop sensor unit the power-delivery information as a power signal indicative of the power amount currently delivered from the power sourcing equipment to the load device.

3. The power droop handling device of claim 1, wherein the droop sensor unit further comprises a data analysis unit which is configured to
receive the power-delivery information in the form of power control data that is exchanged or to be exchanged between the external power sourcing equipment and the external electrical load device, the power control data being indicative of an operational status or instruction regarding power delivery from the power-sourcing equipment to the electrical load device; and
determine or forecast an occurrence of the power-droop condition based on the received power control data.

4. The power droop handling device of claim 1, wherein the maintain-operation signal is further indicative of an instruction to the power sourcing equipment to request the load device to provide the maintain-power-signature pulse with a an increased power.

5. A power sourcing equipment for delivering DC electrical power to at least one external electrical load device, in response to detecting a predetermined maintain-power-signature pulse from the electrical load device, the power sourcing equipment comprising:
a power unit, configured to provide the DC electrical power;
an interface unit comprising at least one connection port, which is connected with the power unit and configured to output the electrical power to the external electrical load device, and to receive the maintain-power-signature pulse from the electrical load device;
at least one power droop handling device of claim 1, which is connected with the power unit for sensing the power amount delivered from the power sourcing equipment to the load device; and
a power sourcing control unit, which is connected with the interface unit and which is configured to discontinue the power delivery to the electrical load device upon establishing a missing-pulse condition in which a respective maintain-power-signature pulse expected according to the repetition rule has not been received, and upon additionally receiving the maintain-operation signal from the power droop handling device under the missing-pulse condition, to temporarily maintain the power delivery to the electrical load device for a predetermined time span.

6. The power sourcing equipment of claim 5, wherein the power sourcing control unit is configured, upon receiving the maintain-operation signal from the power droop handling device, to pause a detection of the maintain-power-signature pulse for the predetermined time span

7. The power sourcing equipment of claim 5, wherein the sourcing control unit is configured, upon receiving the maintain-operation signal from the power droop handling device, to disregard any detected maintain-power-signature pulse for the predetermined time span.

8. The power sourcing equipment of claim 5, wherein the power sourcing control unit is configured to return to normal power delivery upon establishing that the missing-pulse condition has ended.

9. The power sourcing equipment of claim 5, wherein the power sourcing control unit is configured, in case a missing-pulse condition ends before the time span has lapsed, to initialize a second time span upon establishing a reoccurrence of the missing-pulse condition during the time span.

10. The power sourcing equipment of claim 5, wherein the power sourcing control unit further comprises a timing unit, which is configured to determine and store a duration of an established missing-pulse condition, and to determine an extension of the time span in dependence on the stored duration.

11. The power sourcing equipment of claim 10, wherein the timing unit is further configured to
initialize monitoring the time span upon receiving the maintain-operation-signal;
stop monitoring the time span upon establishing that the missing-pulse condition has ended before the time span has lapsed;
discontinue the power delivery to the electrical load device when the time span has lapsed without discontinuation of the missing-pulse condition.

12. The power sourcing equipment of claim 5, comprising the power droop handling device as an internal unit within a housing of the power sourcing equipment.

13. An electrical arrangement comprising
a power sourcing equipment according to claim 5, wherein the interface unit has at least two connection ports;
a power droop handling device that is connected to the power sourcing equipment through a first connection port of the at least two connection ports; and
an electrical load device that is connected to the power sourcing equipment through a second connection port of the at least two connection ports.

14. A droop handling method for controlling DC electrical power delivery from an external power sourcing equipment to an external electrical load device, the power being delivered in response to the power sourcing equipment receiving from the electrical load device a predetermined maintain-power-signature pulse that is repeated according to a repetition rule, the droop handling method comprising:
receiving power-delivery information regarding DC electrical power delivery from the external power sourcing equipment to the external electrical load device,
providing, based on the received power-delivery information, a droop warning signal indicative of a power-droop condition defined by a power amount to be delivered from the power sourcing equipment to the load device falling below a predetermined power threshold value;
in response to the droop warning signal, providing a maintain-operation signal to the external power sourcing equipment, the maintain-operation signal instructing the power sourcing equipment to maintain the power delivery to the electrical load device for a predetermined time span, regardless of whether or not the maintain-power-signature pulse is detected during this time span.

15. A method for operating a power sourcing equipment in delivering DC electrical power to at least one external electrical load device in response to detecting a predetermined maintain-power-signature pulse from the electrical load device, the method comprising:
providing the DC electrical power to the electrical load device;
receiving the maintain-power-signature pulse from the electrical load device;
performing a droop handling method according to claim 14;
upon receiving the maintain-operation signal during performance of the droop handling method of claim 14 under a missing-pulse condition, in which a respective maintain-power-signature pulse expected according to the repetition rule has not been received, temporarily maintaining the power delivery to the electrical load device for a predetermined time span; and
discontinuing the power delivery to the electrical load device upon establishing that the missing-pulse condition continues after the predetermined time span has lapsed.
